(19) United States
(12) Patent Application Publication
(10) Pub. No.: US 2017/0005895 A1
(43) Pub. Date: Jan. 5, 2017

(54) INFORMATION PROCESSING APPARATUS, FAILURE MANAGEMENT METHOD, AND COMPUTER-READABLE RECORDING MEDIUM

(71) Applicant: FUJITSU LIMITED, Kawasaki-shi (JP)

(72) Inventors: Katsuya Sakamoto, Kawasaki (JP); Masanori Kimura, Mishima (JP); KEI OHISHI, CHIGASAKI (JP)

(73) Assignee: FUJITSU LIMITED, Kawasaki-shi (JP)

(21) Appl. No.: 15/193,158

(22) Filed: Jun. 27, 2016

(30) Foreign Application Priority Data
Jun. 30, 2015 (JP) 2015-132033

(51) Int. Cl. H04L 12/26; H04L 29/08

(52) U.S. Cl. CPC H04L 43/0847; H04L 67/16

(57) ABSTRACT

A failure management server stores therein a plurality of failure cases in which the content of failure handling performed in the past in order to handle a failure is associated with the level of a contact person who is in charge of the failure handling. The failure management server stores therein a plurality of pieces of contact person information which are related to each of the contact persons which include level information that indicates the level attached to each of the contact persons. Then, the failure management server acquires, from the level information, the level of the contact person who is in charge of the failure handling that is requested for a search, extracts a failure case on the basis of the acquired level of the contact person, and outputs the extracted failure case as a search result.

### CROSS-REFERENCE TO RELATED APPLICATION

This application is based upon and claims the benefit of priority of the prior Japanese Patent Application No. 2015-132033, filed on Jun. 30, 2015, the entire contents of which are incorporated herein by reference.

### FIELD

The embodiments discussed herein are related to an information processing apparatus, a failure management method, and a computer-readable recording medium.

### BACKGROUND

Conventionally, when a failure occurs in an information processing system, failure recovery is performed by a maintenance person referring to a failure countermeasure database or the like in which past handling cases are recorded. Then, the maintenance person registers the handling content handled by the maintenance person in the failure countermeasure database.

For example, if a hardware failure occurs in a data center, an operation monitoring tool notifies an infrastructure contact person, who is the maintenance person, of the error content. If the infrastructure contact person does not know the countermeasure for the notified error content, the infrastructure contact person searches the failure countermeasure database for the past handling case that is associated with the subject error content. Then, the infrastructure contact person performs the failure recovery in accordance with the searched handling case.

Patent Document 1: Japanese Laid-open Patent Publication No. 2005-242891

Patent Document 2: Japanese Laid-open Patent Publication No. 2001-338121

However, in the technology described above, depending on the level of a maintenance person, it is difficult for the maintenance person to understand the handling case searched from the failure countermeasure database and thus the time taken for the failure recovery becomes long. For example, the degree of detail, the degree of omission, and an amount of information vary in the handling case depending on the skill and technical knowledge of the maintenance person. Consequently, in a case of a maintenance person with a low level, even when searching the failure countermeasure database for a handling case that is described by a maintenance person with a high level, it takes long time for the maintenance person with the low level to understand the handling case, the failure recovery may possibly be extended for a long period of time.

### SUMMARY

According to an aspect of an embodiment, an information processing apparatus includes a memory; and a processor that is connected to the memory, wherein the processor executes a process. The process includes first storing a plurality of failure cases in which the content of failure handling performed in the past in order to handle a failure is associated with the level of a contact person who is in charge of the failure handling in the memory; second storing a plurality of pieces of contact person information which are related to each of the contact persons and which include level information that indicates the level attached to each of the contact persons in the memory; and acquiring, from the plurality of contact person information, a level of a contact person who is in charge of failure handling requested for a search, extracting, on the basis of the acquired level of the contact person, a failure case from the plurality of failure cases, and outputting the extracted failure case as a search result.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram illustrating the overall configuration of a system according to a first embodiment;

FIG. 2 is a functional block diagram illustrating the functional configuration of a failure management server according to the first embodiment;

FIG. 3 is a schematic diagram illustrating an example of information stored in a contact person DB;

FIG. 4 is a schematic diagram illustrating an example of information stored in a failure case management DB;

FIG. 5 is a schematic diagram illustrating an example of information stored in a failure case update DB;

FIG. 6 is a schematic diagram illustrating an example of transition of a screen;

FIG. 7 is a flowchart illustrating the flow of a process;

FIG. 8 is a schematic diagram illustrating an example in which descriptions of a failure response differ depending of the technical level;

FIG. 9 is a schematic diagram illustrating an example of a conversion table; and

FIG. 10 is a schematic diagram illustrating the configuration example of hardware.

### DESCRIPTION OF EMBODIMENTS

Preferred embodiments will be explained with reference to accompanying drawings. Furthermore, the present invention is not limited to the embodiments.

### [a] First Embodiment

### Overall Configuration

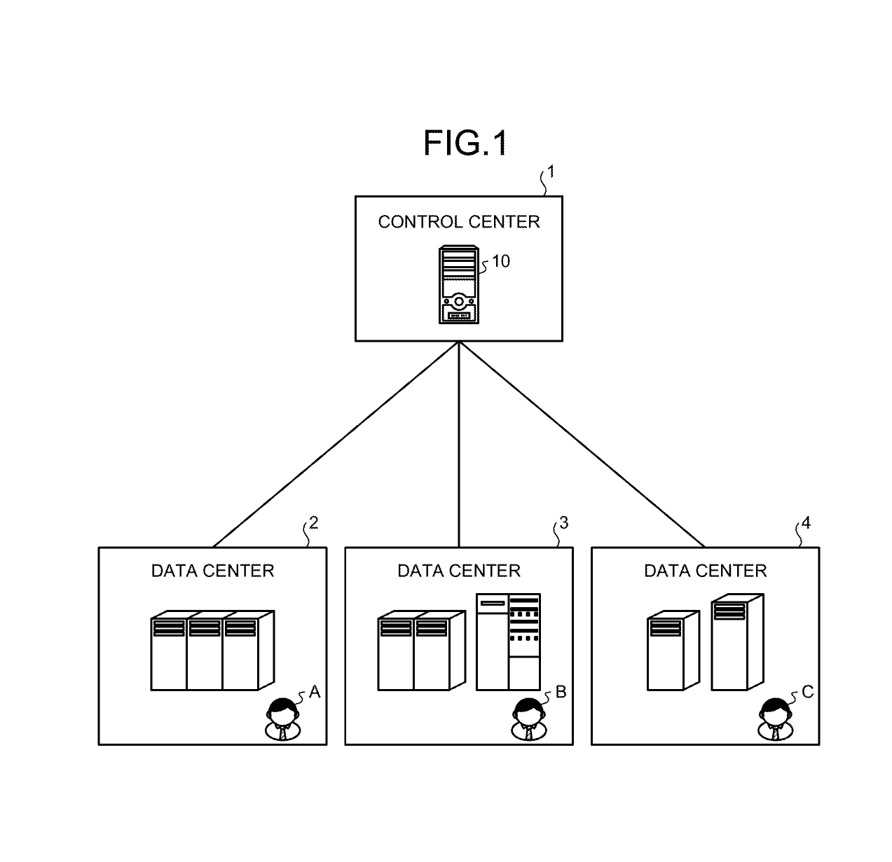

FIG. 1 is a schematic diagram illustrating the overall configuration of a system according to a first embodiment. As illustrated in FIG. 1, this system includes a control center 1, a data center 2, a data center 3, and a data center 4 and each of the centers are connected by a network such that the centers can communicate each other. The number of data centers or the like is exemplified and the setting can be arbitrary changed.

With this system, the data centers 2 to 4 are installed in the countries of the world and the control center 1 performs overall management of each of the data centers. For example, the control center 1 includes a failure management server 10 that stores therein the content of failures that have occurred in each of the data center and the content of the failure handling. The data center 2 is a data center in which a Web server or the like is installed and is installed in Japan. An infrastructure contact person A or the like who manages the infrastructure of the data center 2 is present as an administrator.

Furthermore, the data center 3 is a data center in which a DB server or the like is installed and is installed in the United States. An infrastructure contact person B or the like who manages the infrastructure of the data center 3 is present as an administrator. The data center 4 is a data center in which a Web server, a DB server, or the like is installed and is installed in India. An infrastructure contact person C or the like who manages the infrastructure of the data center 4 is present as an administrator.

In this way, the infrastructure contact persons who maintain the data centers have different nationalities and different technical levels. In contrast, hardware or the like that is used in the system may sometimes be a product from the same vendor and thus the system configuration may sometimes be similar.

In such a system, the failure management server 10 stores therein a failure case in which the content of the failure handling that was performed in the past in order to handle the failure is associated with the level of the contact person who was in charge of the failure handling. The failure management server 10 stores therein information that is related to each of the contact persons and that includes level information that indicates the level attached to each of the contact persons. The failure management server 10 acquires, from the level information, the level of the contact person who is in charge of the failure handling that is requested for a search; extracts a failure case on the basis of the acquired level of the contact person; and outputs the extracted failure case as a search result.

Namely, for the maintenance person who searches for the case of failure handling, the failure management server 10 can select, from the past cases, the case that is described in the same technical level as that of the maintenance person and provide the case. Consequently, it is possible to reduce the time taken for failure recovery.

Functional Configuration

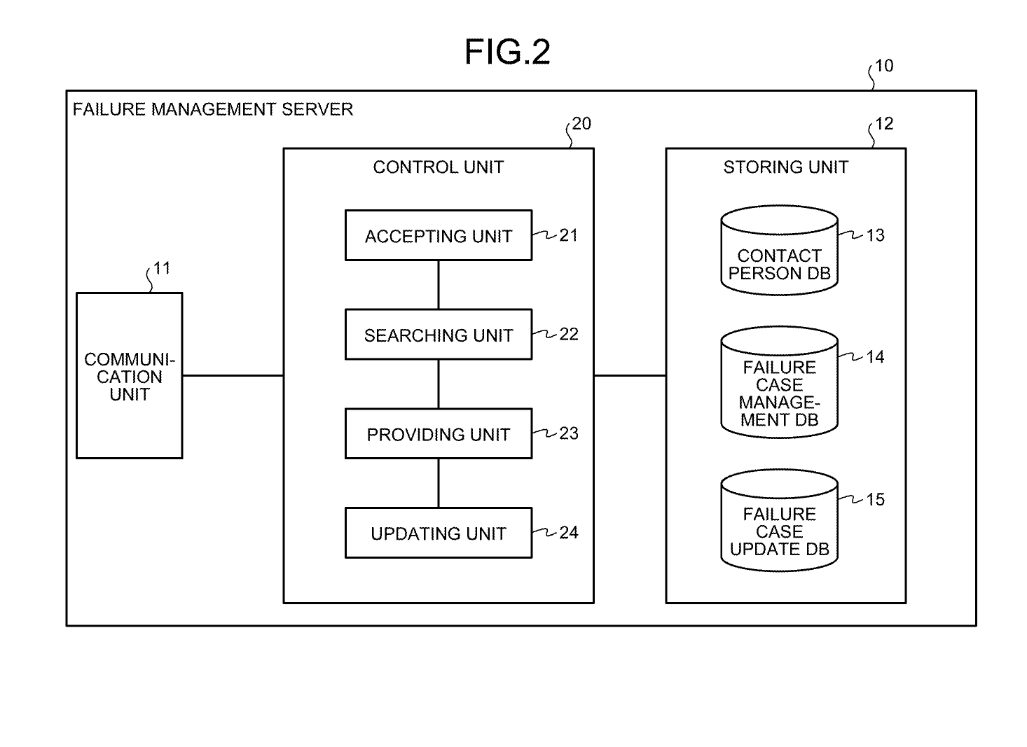

FIG. 2 is a functional block diagram illustrating the functional configuration of the failure management server according to the first embodiment. As illustrated in FIG. 2, the failure management server 10 includes a communication unit 11, a storing unit 12, and a control unit 20.

The communication unit 11 is a processing unit that controls communication with other device irrespective of a wired or wireless manner and is, for example, a network interface card or the like. For example, the communication unit 11 sends and receives to and from each of the data centers various kinds of information and various kinds of data.

The storing unit 12 is a device that stores therein data and various kinds of programs used by the control unit 20 and is an example of a storage device, such as a hard disk, a memory, or the like. The storing unit 12 includes a contact person DB 13, a failure case management DB 14, and a failure case update DB 15.

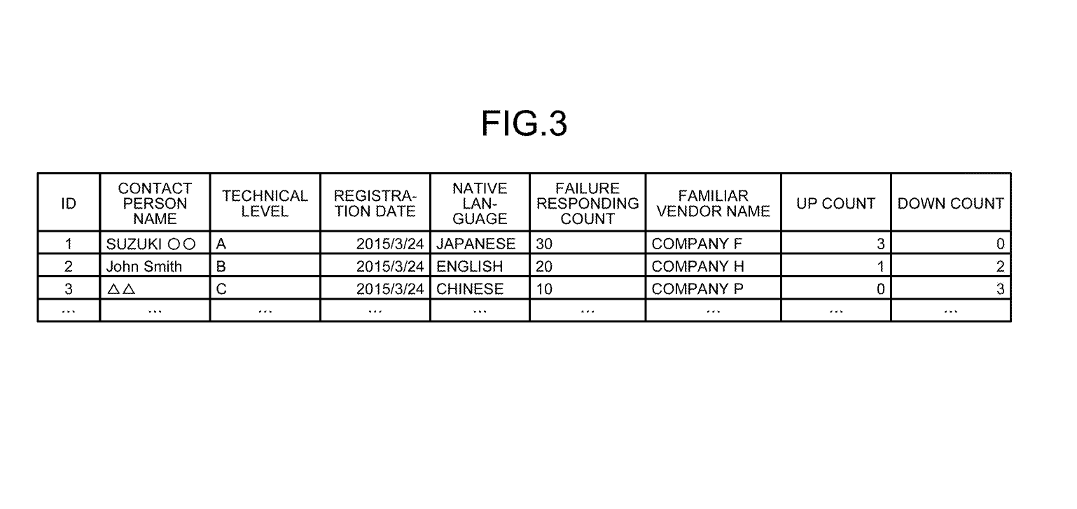

The contact person DB 13 is a database that stores therein contact person information related to each of the infrastructure contact persons in each of the data centers. Specifically, the contact person DB 13 stores therein information that is related to each of the contact persons and that includes the level information indicating the level attached to each of the contact persons. FIG. 3 is a schematic diagram illustrating an example of information stored in the contact person DB. As illustrated in FIG. 3, the contact person DB 13 stores therein the “ID, contact person name, the technical level, the registration date, the native language, the failure responding count, the familiar vendor name, the up count, and the down count”.

The “ID” stored here is an identifier allocated to a contact person and the “contact person name” is the name of an infrastructure contact person. The “technical level” indicates the technical level of the contact person and A indicates the highest level, B indicates the second highest level, and C indicates the third highest level. The “registration date” is the date on which information was registered in the contact person DB 13. The “native language” indicates the native language of the infrastructure contact person and the “failure responding count” indicates the number of items responded by the infrastructure contact person. The “familiar vendor name” indicates the vendor name of a vendor whose product is often used and well understood by the infrastructure contact person. The “up count” is the number of times the infrastructure contact person felt that the content of the referred failure case was easy and is used to raise the technical level. The “down count” is the number of times the infrastructure contact person felt that the content of the referred failure case was difficult or was not easy and is used to lower the technical level.

In the example illustrated in FIG. 3, for the infrastructure contact person (Suzuki OO) with the ID of 1, the native language is Japanese, the technical level is A, and registration was performed on Mar. 24, 2015. Furthermore, the example illustrated in FIG. 3 indicates that the infrastructure contact person (Suzuki OO) is familiar with a company F, performs 30 failure responses up to now, the number of times the infrastructure contact person felt that the content of the failure case is easy is three, the number of times the infrastructure contact person felt that the content of the failure case is not easy is zero. Furthermore, the contact person DB 13 is an example of a contact person information storing unit.

The failure case management DB 14 is a database that stores therein failure cases responded by each of the infrastructure contact persons. Specifically, the failure case management DB 14 stores therein failure cases in which the content of the failure handling performed in the past in order to handle the failure is associated with the level of a contact person who was in charge the failure handling. Furthermore, the failure case is registered and updated by the infrastructure contact person who handled the failure handling.

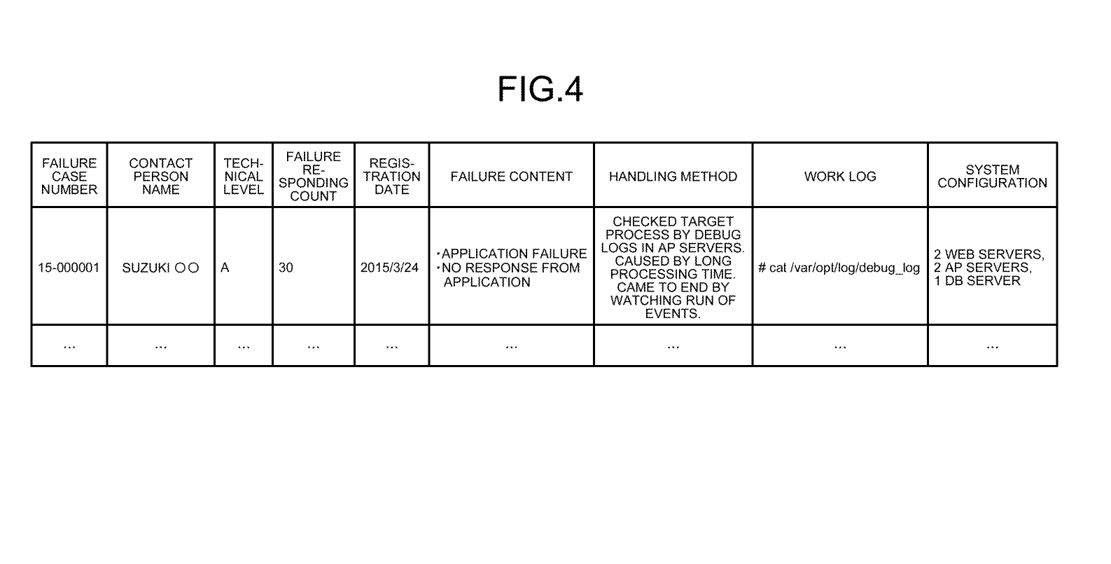

FIG. 4 is a schematic diagram illustrating an example of information stored in the failure case management DB. As illustrated in FIG. 4, the failure case management DB 14 stores therein the failure case in which the “failure case number, the contact person name, the technical level, the failure responding count, the registration date, the failure content, the handling method, the work log, and the system configuration” are associated.

The “failure case number” stored here is an identifier for identifying a failure case, the “contact person name” is an infrastructure contact person who registered the failure case, and the “technical level” is the technical level of the infrastructure contact person who registered the failure case. The “failure responding count” is the number of failures responded by the engineer up to now. The “registration date” is the date on which the failure case was registered, the “failure content” is the content of the handled failure, and the “handling method” is the content of the failure handling. The “work log” is the storage destination of the log created at the time of failure handling and the “system configuration” is the configuration of the system in which the failure occurs.

The example illustrated in FIG. 4 exemplifies the failure case that is identified by “15-000001” and the failure case that was registered on “Mar. 24, 2015” by “Suzuki OO” with the technical level of “A” and with the failure responding count of “30”. This failure case indicates the failure that has occurred in the system configuration with “two WEB servers, two AP servers, and a single DB server” and that is related to “an application failure with no response from the application”. This failure was handled with the note indicating that “Checked the target process by debug logs in the AP servers. Caused by long processing time. Came to an end by watching the run of events” and a work log is stored in “If cat/var/opt/log/debug_log”. Furthermore, the failure case management DB 14 is an example of a case storing unit.

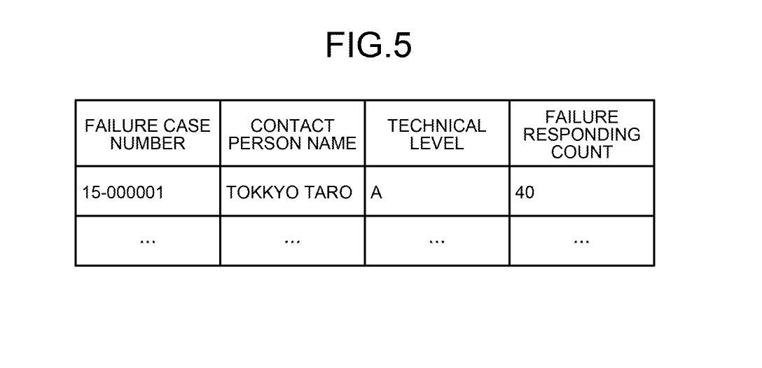

The failure case update DB 15 is a database that stores therein the update history of the failure case stored in the failure case management DB 14. FIG. 5 is a schematic diagram illustrating an example of information stored in the failure case update DB. As illustrated in FIG. 5, the failure case update DB 15 stores therein, in an associated manner, the “failure case number, the contact person name, the technical level, and the failure responding count”.

The “failure case number” stored here is information for specifying an updated failure case and the “contact person name” is the name of the infrastructure contact person who updated the failure case. The “technical level” is the technical level of the infrastructure contact person who updated the failure case and the “failure responding count” is the number of items responded by the infrastructure contact person who updated the failure case up to now. The example illustrated in FIG. 5 indicates that “Tokkyo Taro” with the technical level of “A” and the failure responding count of “40” updated the failure case with the failure case number of “15-000001”.

The control unit 20 is a processing unit that manages overall the failure management server 10 and is, for example, a processor or the like. The control unit 20 includes an accepting unit 21, a searching unit 22, a providing unit 23, and an updating unit 24. Furthermore, the accepting unit 21, the searching unit 22, the providing unit 23, and the updating unit 24 are examples of processes performed by electronic circuits included in the processor or performed by the processor.

The accepting unit 21 is a processing unit that accepts various kinds of information when a failure case is searched. For example, when the accepting unit 21 accepts a search request for a failure case from a client device or the like, the accepting unit 21 sends a login screen to the client device. Then, the accepting unit 21 accepts the ID and the password; performs user authentication; and, if the accepting unit 21 permits the user authentication, requests the searching unit 22 to start a search. Here, the accepting unit 21 searches the contact person DB 13 by using, as the key, the ID that is input at the time of login, whereby the accepting unit 21 can specify the infrastructure contact person who operates the client device.

The searching unit 22 is a processing unit that searches for a failure case by using information that is input by an infrastructure contact person. Specifically, when the searching unit 22 receives an instruction to start a search from the accepting unit 21, the searching unit 22 sends a search screen to the client device in which login is allowed. Then, the searching unit 22 searches the failure case management DB 14 by using, as the key, the search keyword that is input on the search screen and outputs the search result to the providing unit 23.

For example, when the searching unit 22 accepts the “application failure” as the search keyword, the searching unit 22 searches for failure cases in each of which the “application failure” is stored in the failure content from among the failure cases stored in the failure case management DB 14. Then, the searching unit 22 notifies the providing unit 23 of each of the searched failure cases.

The providing unit 23 is a processing unit that outputs a failure case to an infrastructure contact person who is in charge of the failure in accordance with the technical level of the infrastructure contact person who is in charge of the failure in which the content of the failure handling is searched. Specifically, the providing unit 23 acquires the technical level of the infrastructure contact person related to the failure cases to be searched from the accepting unit 21 and acquires the list of the searched failure cases from the searching unit 22. Then, the providing unit 23 submits, to the infrastructure contact person with priority, the failure case that is associated with the technical level that matches the technical level of the infrastructure contact person.

For example, if the technical level that is being searched of the infrastructure contact person is “B”, the providing unit 23 can also send, to the client device, the search screen on which only the failure cases that has the technical level of “B” are displayed from among the searched failure cases. Then, if there is no failure case that matches the searching technical level “B” of the infrastructure contact person, the providing unit 23 can also submit only the failure case, from among the searched failure cases, that has the technical level of “A” or that has the technical level of “C”.

Furthermore, if the searching technical level of the infrastructure contact person is “B”, the providing unit 23 can also send, to the client device, the search screen in which the searched failure cases are sorted such that the failure case with the technical level of “B” is placed at the top. Furthermore, the providing unit 23 can also send, to the client device, the search screen obtained by sorting the searched failure cases in the order the failure case with the technical level of “B”, the failure case of “C” that is lower than “B”, and the failure case of “A” that is higher than “B”.

The updating unit 24 is a processing unit that updates a failure case or that updates the technical level of an infrastructure contact person. Specifically, when the updating unit 24 accepts, from an infrastructure contact person who refers to a failure case, an update of the failure case, the updating unit 24 associates the content of the accepted update with the information of the infrastructure contact person and adds a postscript in the subject failure case. Furthermore, The updating unit 24 registers, in the failure case update DB 15 in an associated manner, the failure case number of the updated failure case and the information on the updated infrastructure contact person. The example of the information on an infrastructure contact person includes the contact person name, the technical level, the failure responding count, or the like and the updating unit 24 can acquire the information via the accepting unit 21. At this time, the updating unit 24 may also register the failure responding count by incrementing by 1.

Furthermore, when the updating unit 24 accepts a registration request for a new case from an infrastructure contact person who searches a failure case, the updating unit 24 sends a registration screen of the new case to the client device. For example, the updating unit 24 allows the search screen to display a “registration” button and, if the “registration” button is selected, the updating unit 24 sends the registration screen to the client device. The updating unit 24 accepts an input of the failure information on the “failure content, the handling method, the work log, and the system configuration” on the registration screen. Then, the updating unit 24 acquires the information on the infrastructure contact person from the accepting unit 21, allocates a unique failure case number to the new failure case in which the information on the infrastructure contact person is associated with the failure information, and registers the new failure case in the failure case management DB 14. At this time, the updating unit 24 may also perform the registration after incrementing the failure responding count by 1.

Furthermore, the updating unit 24 also updates the technical level of the infrastructure contact person. For example, when the updating unit 24 completes the update of the failure case and the registration of the new failure case, the updating unit 24 sends, to the client device, a selection screen for selecting the content of the referred failure case from among “easy, medium, and difficult”. Then, if “easy” is selected, the updating unit 24 increments the up count of the subject infrastructure contact person in the contact person DB 13. Furthermore, if “difficult” is selected, the updating unit 24 increments the down count of the subject infrastructure contact person in the contact person DB 13.

More specifically, the updating unit 24 refers to the failure case in which the infrastructure contact person has the same technical level as the own technical level; if “difficult” is selected, the updating unit 24 increments the down count; if “easy” is selected, the updating unit 24 increments up count; and, if “medium” is selected, the updating unit 24 maintains the current state. Furthermore, the updating unit 24 refers to the failure case in which the infrastructure contact person has the technical level higher than the own technical level; if “difficult” is selected, the updating unit 24 maintains the current state; and, if “easy” or “medium” is selected, the updating unit 24 increments the up count. Furthermore, the updating unit 24 refers to the failure case in which the infrastructure contact person has the technical level lower than the own technical level; if “medium” or “easy” is selected, the updating unit 24 maintains the current state; and, if “difficult” is selected, the updating unit 24 increments the down count.

Then, if the up count of the subject infrastructure contact person becomes equal to or greater than a threshold (for example, 5), the updating unit 24 increments the technical level of the subject infrastructure contact person by 1. For example, if the technical level registered in the contact person DB 13 is B, the updating unit 24 updates the technical level to A; if the technical level is C, the updating unit 24 updates the technical level to B; and, if the technical level is A, the updating unit 24 maintains A.

Furthermore, if the down count of the subject infrastructure contact person becomes equal to or greater than a threshold (for example, 5), the updating unit 24 decrements the technical level of the subject infrastructure contact person by 1. For example, if the technical level registered in the contact person DB 13 is B, the updating unit 24 updates the technical level to C; if the technical level is A, the updating unit 24 updates the technical level to B; and, if the technical level is C, the updating unit 24 maintains C.

Example of Transition of a Screen

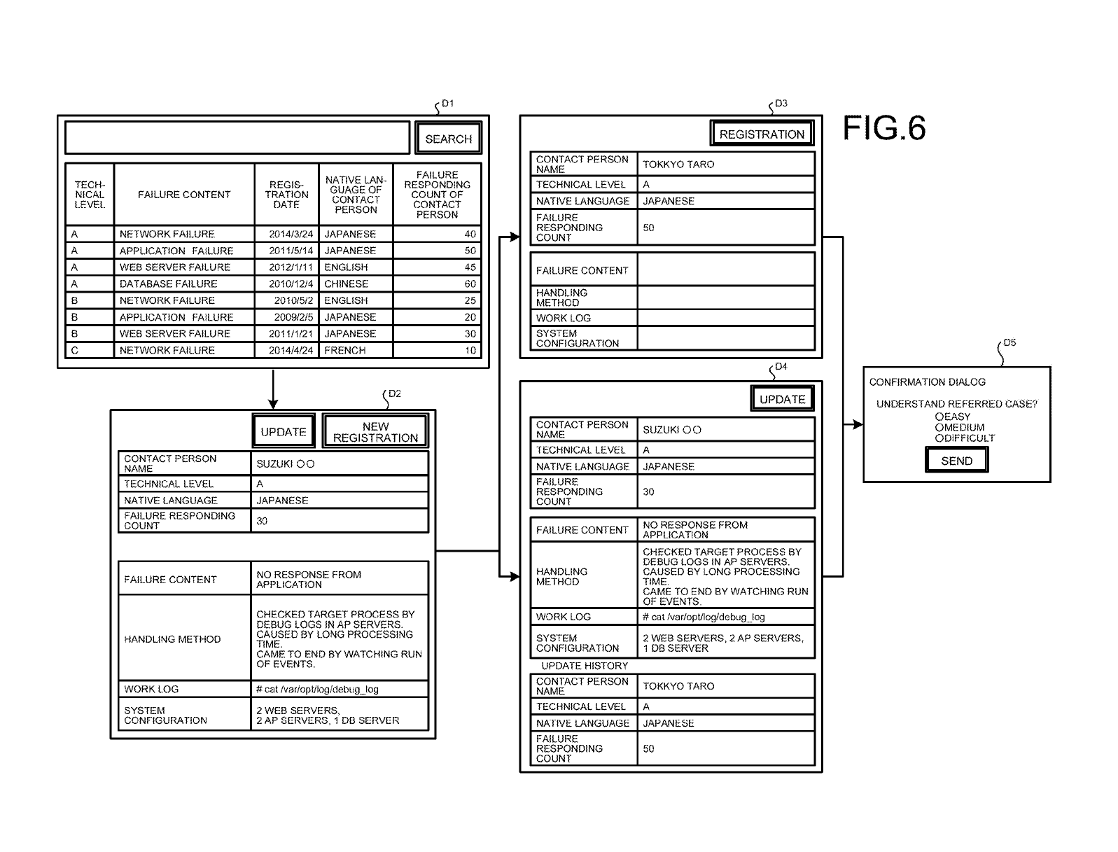

In the following, a description will be given of an example of a screen that is sent, by the failure management server 10, to a client device used by an infrastructure contact person. FIG. 6 is a schematic diagram illustrating an example of transition of a screen. Furthermore, here, it is assumed that the technical level of the infrastructure contact person who searches for a failure case is “A”.

As illustrated in FIG. 6, the providing unit 23 sends, to the client device, the search result in which the failure cases with the technical level of “A” are displayed at the top (D1). Here, the providing unit 23 extracts, from each of the searched failure cases and contact person information, the technical level, a part of the failure content, the registration date, the native language of the contact person, and the failure responding count of the contact person and displays the extracted items.

Subsequently, when the “application failure” of the technical level “A” is selected, the providing unit 23 acquires, from the contact person DB 13, the contact person information “Suzuki OO” on the engineer who registered the subject failure case and reads the subject failure case from the failure case management DB 14. Then, the providing unit 23 sends, to the client device, a detailed screen obtained by combining the contact person information “Suzuki OO” with the failure case indicated by the “failure content, the handling method, the work log, and the system configuration” (D2).

Then, if the “new registration” button is selected on the detailed screen, the updating unit 24 sends the registration screen of the failure case to the client device (D3). Specifically, the updating unit 24 extracts, from the contact person DB 13, the contact person information on the infrastructure contact person “Tokkyo Taro” who currently performs the search. Then, the updating unit 24 sends, to the client device, the registration screen on which the contact person information on the infrastructure contact person “Tokkyo Taro” and the input areas indicated by the “failure content, the handling method, the work log, and the system configuration” are displayed. Then, if an input of each of the input areas in the registration screen has been completed and the “registration” button is selected, the updating unit 24 stores the input information in the failure case management DB 14.

In contrast, if the “update” button is selected on the detailed screen, the updating unit 24 sends the update screen of the failure case to the client device (D4). Specifically, the updating unit 24 extracts, from the contact person DB 13, the contact person information on the infrastructure contact person “Tokkyo Taro” who currently performs the search. Then, the updating unit 24 sends, to the client device, the update screen in which the contact person information on the infrastructure contact person “Tokkyo Taro” is further displayed on the detailed screen. Furthermore, the updating unit 24 displays the “failure content, the handling method, the work log, and the system configuration” on the update screen in the state they can be updated. Then, if the “update” button is selected on the update screen, the updating unit 24 updates, by using the updated information, the subject failure case registered in the failure case management DB 14. Furthermore, the updating unit 24 registers the updated information on the infrastructure contact person in the failure case update DB 15.

When the processes of the registration screen and the update screen have been ended, the updating unit 24 sends, to the client device, the confirmation dialog for inquiring the degree of understanding of the referred failure case (D5). Then, the updating unit 24 updates the contact person DB 13 in accordance with the selection state in the confirmation dialog.

Flow of a Process

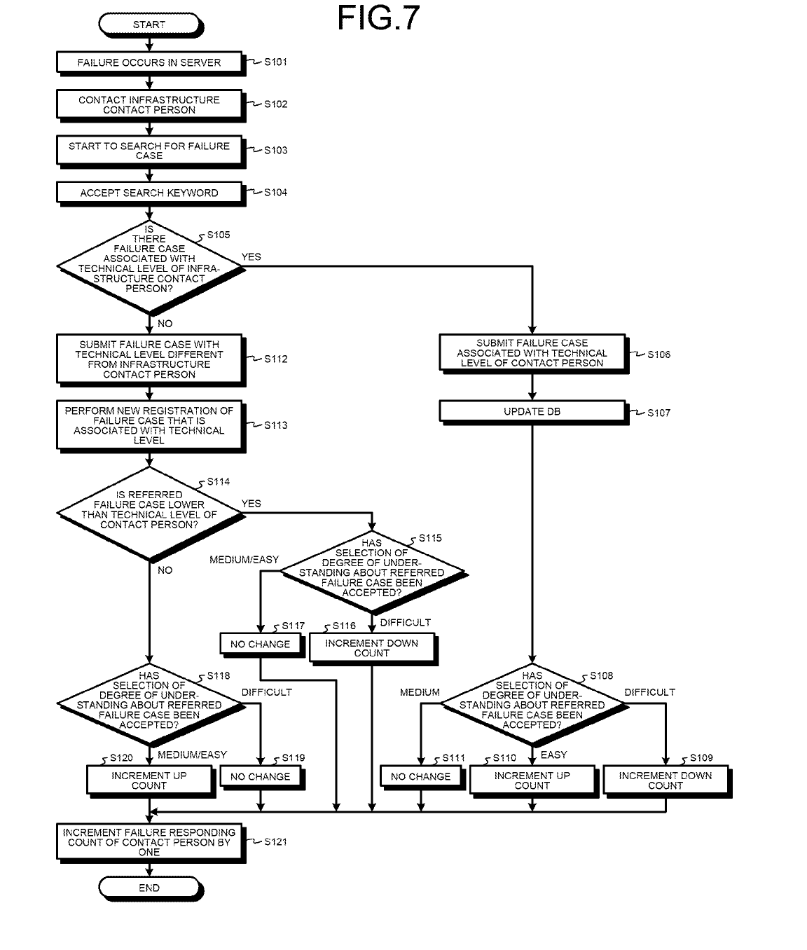

In the following, a description will be given of the flow of the series of processes described above. FIG. 7 is a flowchart illustrating the flow of a process. Here, as an example, a description will be given of an example of displaying only the failure case with a single technical level.

As illustrated in FIG. 7, if a failure occurs in the server in the data center 2 (Step S101), a failure notification from the management tool installed in the server to the infrastructure contact person A occurs (Step S102).

Thereafter, the infrastructure contact person A accesses the failure management server 10 by using the client device and starts to search for the failure case (Step S103). Then, the accepting unit 21 in the failure management server 10 accepts a search keyword (Step S104).

Subsequently, the searching unit 22 in the failure management server 10 searches the failure case management DB 14 for the failure case that corresponds to the search keyword and the providing unit 23 determines whether a failure case associated with the technical level of the infrastructure contact person A is present (Step S105).

Then, if the failure case associated with the technical level of the infrastructure contact person A is present (Yes at Step S105), the providing unit 23 submits the failure case associated with the technical level of the infrastructure contact person A to the client device (Step S106). Thereafter, if the updating unit 24 accepts a postscript of complementary information with respect to the referred failure case, the updating unit 24 updates the failure case in the failure case management DB 14 or updates the update history of the failure case update DB 15 (Step S107).

Subsequently, when the updating unit 24 ends the various kinds of updates in the DB, the updating unit 24 sends the confirmation dialog and accepts the degree of understanding of the infrastructure contact person with respect to the referred failure case (Step S108). Then, if “difficult” is selected (difficult at Step S108), the updating unit 24 increments the down count of the subject infrastructure contact person by 1 (Step S109). Furthermore, if “easy” is selected (easy at Step S108), the updating unit 24 increments the up count of the subject infrastructure contact person by 1 (Step S110). Furthermore, if “medium” is selected (medium at Step S108), the updating unit 24 does not change the up count and the down count of the subject infrastructure contact person (Step S111).

In contrast, at Step S105, if there is no failure case associated with the technical level of the infrastructure contact person A (No at Step S105), the providing unit 23 submits the failure case with the technical level different from the infrastructure contact person A to the client device (Step S112).

Then, when the updating unit 24 accepts a new registration of the failure case that is associated with the technical level of the infrastructure contact person, the updating unit 24 accepts various kinds of information and registers the information in the failure case management DB (Step S113).

Thereafter, if the new registration of the failure case has been ended, the updating unit 24 determines whether, for example, the failure case that is referred by the infrastructure contact person last time is lower than the technical level of the subject infrastructure contact person (Step S114).

Then, if the referred failure case is lower than the technical level of the infrastructure contact person (Yes at Step S114), the updating unit 24 sends the referred confirmation dialog and accepts the degree of understanding of the infrastructure contact person with respect to the referred failure case (Step S115).

Here, if “difficult” is selected (difficult at Step S115), the updating unit 24 increments the down count of the subject infrastructure contact person by 1 (Step S116). Furthermore, if “medium” or “easy” is selected (medium/easy at Step S115), the updating unit 24 does not change the up count and down count of the subject infrastructure contact person (Step S117).

In contrast, if the referred failure case is higher than the technical level of the infrastructure contact person (No at Step S114), the updating unit 24 sends the confirmation dialog and accepts the degree of understanding of the infrastructure contact person with respect to the referred failure case (Step S118).

At this point, if “difficult” is selected (difficult at Step S118), the updating unit 24 does not change the up count and the down count of the subject infrastructure contact person (Step S119). Furthermore, if “medium” or “easy” is selected (medium/easy at Step S118), the updating unit 24 increments the up count of the subject infrastructure contact person by 1 (Step S120).

Then, if the updating unit 24 ends the processes described above, the updating unit 24 increments the failure responding count of the target infrastructure contact person by 1 (Step S121) and ends the processes.

Advantage

As described above, if there is no case closer to the own technical level of the infrastructure contact person, the infrastructure contact person performs failure handling by referring to the failure case that is registered by a contact person with another technical level. Then, after the failure handling, the infrastructure contact person registers the case in the database together with the own technical level. Furthermore, if there is a case closer to the own technical level of the infrastructure contact person, the infrastructure contact person performs the failure handling by referring to the failure case that is registered by the contact person with the technical level that is closer to the own level. Then, after having performed the failure handling by referring to the case, the infrastructure contact person adds complementary information as a postscript with respect to the registered case.

In this way, the failure management server 10 can submit the information associated with the technical level of the infrastructure contact person. Furthermore, if the existing case is present, the failure management server 10 can complement information to the subject case, suppress too much information, and save trouble of a search performed by the infrastructure contact person.

Furthermore, the failure management server 10 can submit a failure case that is described by using the terms at the technical level of the infrastructure contact person. Consequently, it is possible to reduce the time taken for the infrastructure contact person to understand the handling content of the searched failure case and hasten the start of the failure handling. Consequently, it is possible to reduce the time taken for the failure recovery.

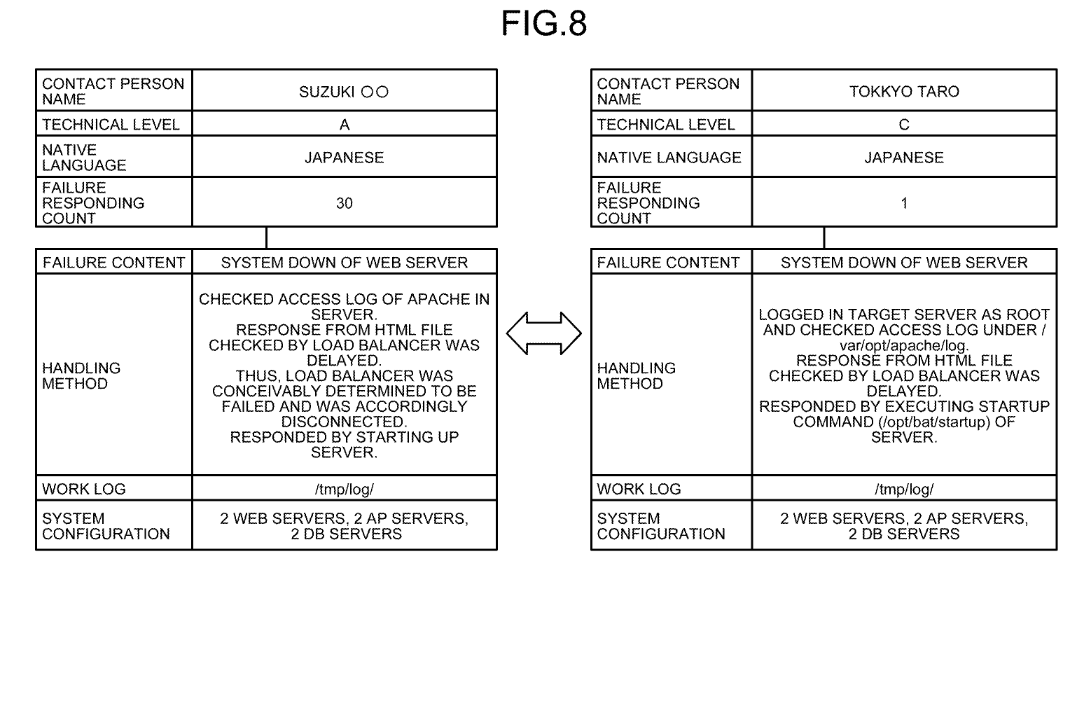

FIG. 8 is a schematic diagram illustrating an example in which descriptions of a failure response differ depending on the technical level. The failure cases illustrated on the left and the right side of FIG. 8 indicate the handling content of the same failure of “system down of a WEB server”.

The diagram on the left side of FIG. 8 illustrates the handling content described by the infrastructure contact person “Suzuki OO” with the technical level of “A”. The infrastructure contact person with the high technical level inputs a description in a handling method with the note indicating that “Checked the access log of apache in the server. The response from the html file checked by a load balancer was delayed. Thus, the load balancer was conceivably determined to be failed and was accordingly disconnected. Responded by starting up the server.” The content of this description indicates the difficult technical content because it is not able for an engineer to describe prediction of the cause without the knowledge related to the infrastructure.

The diagram on the right side of FIG. 8 illustrates the handling content described by the infrastructure contact person “Tokkyo Taro” with the technical level of “C”. The infrastructure contact person with the low technical level inputs a description in a handling method with the note indicating that “Logged in the target server as root and checked the access log under /var/opt/apache/log. The response from the html file checked by a load balancer was delayed. Responded by executing the startup command (/opt/bat/startup) of the server”. The content of this description indicates the technical content that can be handled by anyone who reads this description because the technique of the login, the storage destination of the log, and the content of the command are specifically described.

Conventionally, if an infrastructure contact person with a low technical level searches for a failure case, the infrastructure contact person may sometimes search for the failure case illustrated on the left side of FIG. 8 because the technical level is not considered. In this case, the infrastructure contact person is not able to understand the content of the failure case and is not able to promptly perform the failure handling. Furthermore, the infrastructure contact person accordingly repeats the search process until the failure case illustrated on the right side of FIG. 8 is searched. Consequently, the time taken for the failure recovery becomes long.

In contrast, if an infrastructure contact person with a high technical level searches for a failure case, the infrastructure contact person may sometimes search for the failure case illustrated on the right side of FIG. 8 because the technical level is not considered. In this case, the content with a low technical level is often present, which may possibly be a limiting factor of understanding the handling content. Furthermore, because the search process may sometimes be repeated until the failure case illustrated on the left side of FIG. 8 is searched, the time taken for the failure recovery may sometimes be long.

When compared with these cases, the failure management server 10 described above can submit, with priority to an infrastructure contact person with a high technical level, the failure case described by using technical terms, as illustrated on the left side of FIG. 8. Furthermore, the failure management server 10 described above can submit, with priority to an infrastructure contact person with a low technical level, the failure case in which specific handling content is described with fewer technical terms, as illustrated on the right side of FIG. 8. Accordingly, because each of the infrastructure contact persons can refer to the handling content in accordance with the own level, the infrastructure contact persons can promptly understand the handling content. Consequently, the time taken for the failure recovery can be reduced.

### [b] Second Embodiment

In the above explanation, a description has been given of the embodiments according to the present invention; however, the present invention may also be implemented with various kinds of embodiments other than the embodiments described above.

Translation

For example, the failure management server 10 can submit a failure case after translating the failure case into the native language of an infrastructure contact person. Specifically, the failure management server 10 specifies, from the contact person DB 13, the native language of the infrastructure contact person who performs a search. Then, the failure management server 10 translates the searched failure case into the specified native language and then submits the translated failure case to the infrastructure contact person. By doing so, it is possible to reduce the time taken for the infrastructure contact person to understand the failure case.

Conversion

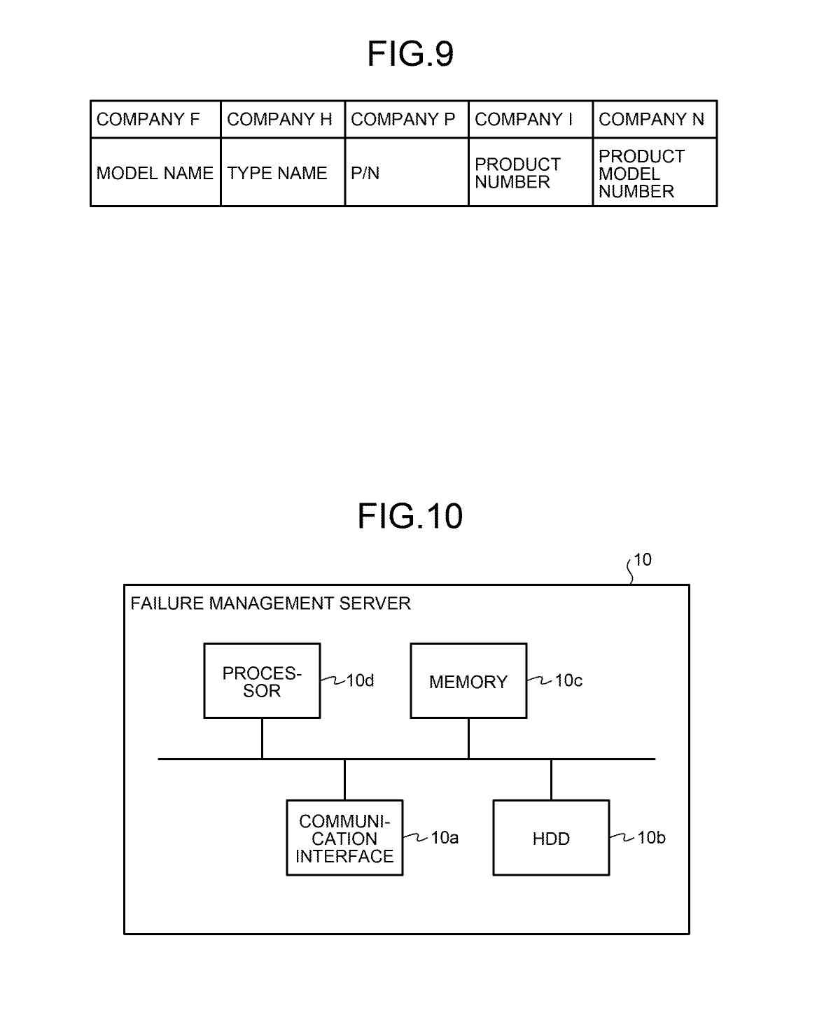

Furthermore, the failure management server 10 may also be possible to submit the failure case after converting the failure case to the language that is used by a vendor that is familiar to the infrastructure contact person. FIG. 9 is a schematic diagram illustrating an example of a conversion table. As illustrated in FIG. 9, the conversion table stores therein, in an associated manner, the languages used by a company F, a company H, a company P, a company I, and a company N. The example illustrated in FIG. 9 indicates that the “model name” that is used by the product of the company F, the “type name” that is used by the product of the company H, “P/N” that is used by the product of the company P, the “product number” that is used by the product of the company I, and the “product model number” that is used by the product of the company N are the same.

In this state, the failure management server 10 refers to the contact person DB 13 and specifies that the vendor that is familiar to the infrastructure contact person is the company F. Furthermore, the failure management server 10 refers to the contact person DB 13 and specifies that the vendor that is familiar to the engineer who described the failure case that was selected by the infrastructure contact person is the company I. Consequently, when the failure management server 10 submits a failure case to the infrastructure contact person, the failure management server 10 converts, by using the conversion table illustrated in FIG. 9, the language that is used by the company I for the failure case to the language that is used by the company F and then submits the failure case. By doing so, the infrastructure contact person can reduce the time taken to understand the failure case and suppress wrong understanding. Furthermore, the conversion table is an example of a word storing unit.

Application Field

In the embodiments described above, a description has been given by using a failure case as an example; however, the embodiments are not limited to this. For example, the same process can be used for technical documents, manuals of products or systems, or the like.

Technical Level

For example, the initial value of the technical level at the time of starting the operation of the system described above can be determined in accordance with the number of years a contact person involved. For example, if the number of years the infrastructure contact person involved is equal to or greater than 15, the technical level is determined to be “A”; if the number of years the infrastructure contact person involved is equal to or greater than 5 and less than 15, the technical level is determined to be “B”; and, if the number of years the infrastructure contact person involved is less than 5, the technical level is determined to be “C”. Furthermore, an arbitrary level can be set irrespective these three levels of A, B, and C.

System

Furthermore, the components of each unit illustrated in the drawings are not always physically configured as illustrated in the drawings. In other words, the components may also be configured by separating or integrating any of the units. Furthermore, all or any part of the processing functions performed by each device can be implemented by a CPU and by programs analyzed and executed by the CPU or implemented as hardware by wired logic.

Of the processes described in the embodiment, the whole or a part of the processes that are mentioned as being automatically performed can also be manually performed, or the whole or a part of the processes that are mentioned as being manually performed can also be automatically performed using known methods. Furthermore, the flow of the processes, the control procedures, the specific names, and the information containing various kinds of data or parameters indicated in the above specification and drawings can be arbitrarily changed unless otherwise stated.

Hardware

FIG. 10 is a schematic diagram illustrating the configuration example of hardware. As illustrated in FIG. 10, the failure management server 10 includes a communication interface 10a, a hard disk drive (HDD) 10b, a memory 10c, and a processor 10d. Furthermore, the units illustrated in FIG. 10 are connected each other by a bus or the like. Furthermore, the hardware illustrated here is an example and, for example, another piece of hardware, such as a graphics interface, a mouse, or the like, may also be included.

The communication interface 10a is an interface that controls the communication with other devices and is, for example, a network interface card. The HDD 10b stores therein a program that operates the function illustrated in FIG. 2 or the like and the DBs illustrated in FIGS. 3 to 5.

The processor 10d reads the program that performs the same process as that performed by each of the processing units illustrated in FIG. 2 or the like from the HDD 10b or the like and loads the program in the memory 10c, thus operating the process that executes each of the functions described in FIG. 2 or the like.

Namely, the process executes the same function as that performed by each of the processing units included in the failure management server 10. Specifically, the processor 10d reads the program having the same function as that performed by the accepting unit 21, the searching unit 22, the providing unit 23, and the updating unit 24 from the HDD 10b or the like. Then, the processor 10d executes a process that executes the same process as that performed by the accepting unit 21, the searching unit 22, the providing unit 23, and the updating unit 24.

In this way, by reading and executing the program, the failure management server 10 operates as an information processing apparatus that executes a failure management method. Furthermore, the program is recorded in a computer readable recording medium, such as a hard disk, a flexible disk, a compact disk-read only memory (CD-ROM), a magneto optical (MO) disk, a digital versatile disk (DVD), or the like and is executed by being read by the computer from the recording medium. Furthermore, the program mentioned in the embodiments is not limited to be executed by the failure management server 10. For example, the present invention may also be similarly used in a case in which another computer or a server executes the program or in which another computer and a server cooperatively execute the program with each other.

According to an aspect of the embodiment, the time taken for failure recovery can be reduced.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor that is connected to the memory, wherein the processor executes a process including:
first storing a plurality of failure cases in which the content of failure handling performed in the past in order to handle a failure is associated with the level of a contact person who is in charge of the failure handling in the memory;
second storing a plurality of pieces of contact person information which are related to each of the contact persons and which include level information that indicates the level attached to each of the contact persons in the memory; and
acquiring, from the plurality of pieces of contact person information, a level of a contact person who is in charge of failure handling requested for a search, extracting, on the basis of the acquired level of the contact person, a failure case from the plurality of failure cases, and outputting the extracted failure case as a search result.

2. The information processing apparatus according to claim 1, wherein the extracting includes extracting, from among the plurality of failure cases associated with the content of the failure handling requested for the search, the failure case that is associated with the same level as that of the contact person.

3. The information processing apparatus according to claim 1, wherein
the extracting includes extracting a first failure case that is associated with the same level as that of the contact person, a second failure case that is associated with the level lower than that of the contact person, and a third failure case that is associated with the level higher than that of the contact person,
the outputting includes outputting the first failure case, the second failure case and the third failure case as the search results in the order of the levels.

4. The information processing apparatus according to claim 1, wherein the process further comprises updating, in accordance with the level that is associated with the failure case output to each of the contact persons, the level of the each of the contact persons registered in the level information in the plurality of pieces of contact person information.

5. The information processing apparatus according to claim 1, wherein
the second storing includes storing home country information that indicates the native language of each of the contact persons in the plurality of pieces of contact person information, and
the outputting includes specifying the native language of the contact person from the home country information in the plurality of pieces of contact person information, translating the failure case in accordance with the specified native language, and outputting the translated failure case.

6. The information processing apparatus according to claim 1, wherein the process further comprises third storing word information that is associated with words that are the same meaning among vendors in the memory, wherein
the second storing includes storing vendor name information that indicates vendor names that are familiar to the corresponding contact persons in the plurality of pieces of contact person information, and
the outputting includes specifying, from the vendor name information in the plurality of pieces of contact person information, a vendor name that is familiar to the contact person, translating a failure case in accordance with the word information associated with the specified vendor name, and outputting the translated failure case.

7. A failure management method comprising:
acquiring the level of a contact person who is in charge of failure handling that is requested for a search from level information in a contact person information storing unit that stores therein a plurality of pieces of contact person information which are related to each of the contact persons which include the level information indicating the level attached to each of the contact persons, using a processor; and
extracting, from a case storing unit that stores therein a plurality of failure cases in which the content of failure handling performed in the past in order to handle a failure is associated with the level of a contact person who is in charge of the failure handling, a failure case on the basis of the acquired level of the contact person and outputting the extracted failure case as a search result, using the processor.

8. A non-transitory computer-readable recording medium having stored therein a failure management program that causes a computer to execute a process comprising:
acquiring the level of a contact person who is in charge of failure handling that is requested for a search from level information in a contact person information storing unit that stores therein a plurality of pieces of contact person information which are related to each of the contact persons which include the level information indicating the level attached to each of the contact persons; and
extracting, from a case storing unit that stores therein a plurality of failure cases in which the content of failure handling performed in the past in order to handle a failure is associated with the level of a contact person who is in charge of the failure handling, a failure case on the basis of the acquired level of the contact person and outputting the extracted failure case as a search result.
